(19) United States
(12) Patent Application Publication
(10) Pub. No.: US 2025/0303953 A1
(43) Pub. Date: Oct. 2, 2025

(54) Multipurpose Strap System

(71) Applicant: David Kanas, Auburn, CA (US)

(72) Inventor: David Kanas, Auburn, CA (US)

(21) Appl. No.: 18/618,052

(22) Filed: Mar. 27, 2024

(51) Int. Cl. B60P 7/08

(52) U.S. Cl. CPC B60P 7/0823

(57) ABSTRACT

A multipurpose strap system is provided. The multipurpose strap system includes an elongated main strap with first and second fasteners affixed at respective ends. The first and second fasteners form closed loops on the first side of the elongated main strap, allowing versatile applications for coupling items, securing to itself, or other similar straps. The system further includes an extension attachment, providing adaptability. The strap system lacks hooks to improve safety and ease of use. The fasteners include two components, with one fastener component being permanently secured to the main strap on one side and the other fastener component being secured on the other side, such that it extends past a distal end of the main strap. The closure of the fastener components allows for the formation of a closed loop that secures items or other straps to the multipurpose strap system.

### BACKGROUND OF THE INVENTION

The present invention relates to a multipurpose strap system. The multipurpose strap system comprises an elongated main strap affixed to a first fastener and a second fastener, wherein the elongated strap has a first side, a second side, a first end, and a second side. The first fastener includes a first component of the first fastener and a second component of the first fastener at the first end. The second fastener includes a first component of the second fastener and a second component of the second fastener at the second end. The first component of the first fastener and the first component of the second fastener are located on the first side of the elongated main strap, wherein the second component of the first fastener and the second component of the second fastener are located on the first side of said strap and extend past each distal end of the elongated main strap. The first component of the first and second fasteners are each configured to couple with the second component of the first and second fasteners, respectively, and each form a closed loop. In this way, the multipurpose strap system provides a dynamic hook-and-loop fastening mechanism that is reconfigurable as needed by the user.

In a world where the utility of straps spans a multitude of applications, from securing cargo during transportation to bundling camping equipment, the pervasive use of traditional strap designs, often featuring hooks, has given rise to inherent challenges. Common uses of straps encompass securing goods in transit, bundling items for storage, and fastening everyday objects to each other. Straps find application in “do-it-yourself” projects, aiding in the construction of temporary structures or securing materials during home renovations. Moreover, straps are frequently employed in outdoor activities such as securing tents during camping expeditions, ensuring a stable and wind-resistant shelter.

However, despite their prevalence, conventional strap designs have encountered inherent issues that impact both functionality and safety. Within this landscape, traditional strap designs and bungee cords have predominantly been constructed using materials like nylon or polyester offering an elastic function. A prevalent challenge arises from straps equipped with hooks, intended for diverse uses such as securing a dog crate to the interior of a car, fastening items to a bike rack, or bundling tools. While hooks serve their purpose, they present a significant drawback, posing risks of damage to both the secured items and the surfaces they come into contact with. For instance, hooks can scratch or dent the exteriors of vehicles, damage delicate products, or even pose safety hazards in certain applications. For example, hooks positioned at the ends of an elastic cord may contract upon a release of tension causing the hooks to injure the user. These shortcomings have been a persistent challenge for individuals seeking a multi-purpose strap system.

In view of these developments, there exists a need for a multipurpose strap system that eliminates the need for hooks for fastening items and utilizes a silicone-reinforced composition with fiberglass. Distinct from rigid hooks commonly found in traditional strap designs, the multipurpose strap system utilizes corresponding fastener components, such as hook-and-loop fasteners, that are positioned on opposing sides of the main band to selectively form a loop at the end. The user may selectively close the loop around objects to couple the strap system to the object. Through this modular design, the user gains the ability to securely fasten the strap around various objects, enhancing adaptability and versatility in application scenarios.

By introducing a dynamic hook-and-loop fastening mechanism to a durable band, the multipurpose strap system enables users to selectively create loops, ensuring secure and damage-free fastening around diverse objects. This device not only addresses the evolving needs of modern users but is adaptable as a superior alternative in the realm of secure and versatile strap applications.

In light of the devices disclosed in the known art, it is submitted that the present invention substantially diverges in design elements and methods from the known art and consequently it is clear that there is a need in the art for an improvement in multipurpose straps with various fastening configurations. In this regard the instant invention substantially fulfills these needs.

### SUMMARY OF THE INVENTION

In view of the foregoing disadvantages inherent in the known types of multipurpose strap systems, the present invention provides dynamic hook-and-loop fastening mechanism allows for secure and versatile fastening. The elongated strap includes distinct sides and ends which incorporates a first fastener with components at one end and a second fastener with components at the opposite end. The second component of the first fastener and the second component of the second fastener are located on the first side of said strap and extend past each distal end of the elongated main strap. The first component of the first and second fasteners are each configured to couple with the second component of the first and second fasteners, respectively, and each form a closed loop.

It is an objective of the present invention to provide an embodiment of the multipurpose strap system that offers users the ability to adjust and modify the strap according to specific requirements. The configuration of fasteners and respective components allows for flexible usage making it a versatile tool in various applications, from bundling items to securing loads during transportation.

It is yet another objective of the present invention to provide an embodiment of the multipurpose strap system that incorporates a silicone-reinforced composition with fiberglass in the construction. The strap provides a robust solution for secure fastening while accommodating diverse applications in different environments.

It is an objective of the present invention to provide an embodiment of the multipurpose strap system that is configured to daisy chain with other similar strap systems. The daisy-chaining offers a scalable solution for securing larger or irregularly shaped items. Moreover, when multiple strap systems are connected simultaneously, the strap system allows users to form a net-like configuration.

It is also another objective of the present invention to provide an embodiment of the multipurpose strap system that eliminates the need to utilize traditional hooks for securing objects to vehicles and the like. The absence of rigid hooks mitigates the risk of injury or other damage to objects, including both secured items and their surroundings.

It is therefore an object of the present invention to provide a new and improved multipurpose strap system that has all of the advantages of the known art and none of the disadvantages.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the multipurpose strap system.

FIG. 2 shows a close-up view of an embodiment of the first end of the multipurpose strap system in a closed configuration.

FIG. 3 shows a close-up view of an embodiment of the first end of the multipurpose strap system in an open configuration.

FIG. 4 shows a perspective view of an embodiment of the multipurpose strap system joined with multiple other straps in a net configuration.

FIG. 5 shows a perspective view of an embodiment of the multipurpose strap in a coiled configuration with a phosphorescent substrate to emit some light.

FIG. 6 shows a perspective view of an embodiment of the multipurpose strap with an elastic auxiliary cord affixed to a non-elastic auxiliary cord.

### DETAILED DESCRIPTION OF THE INVENTION

Reference is made herein to the attached drawings. Like reference numerals are used throughout the drawings to depict like or similar elements of the system. For the purpose of presenting a brief and clear description of the present invention, the embodiment discussed will be used for securing items to the strap and the strap to other straps and/or fixed objects. The figures are intended for representative purposes only and should not be considered to be limiting in any respect. Furthermore, the described features, structures, or characteristics may be combined in any suitable manner in one or more embodiments. In the following description, numerous specific details are provided to give a thorough understanding of embodiments.

Reference will now be made in detail to the exemplary embodiment(s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment,” “first embodiment”, “second embodiment”, or “third embodiment” does not necessarily refer to the same embodiment.

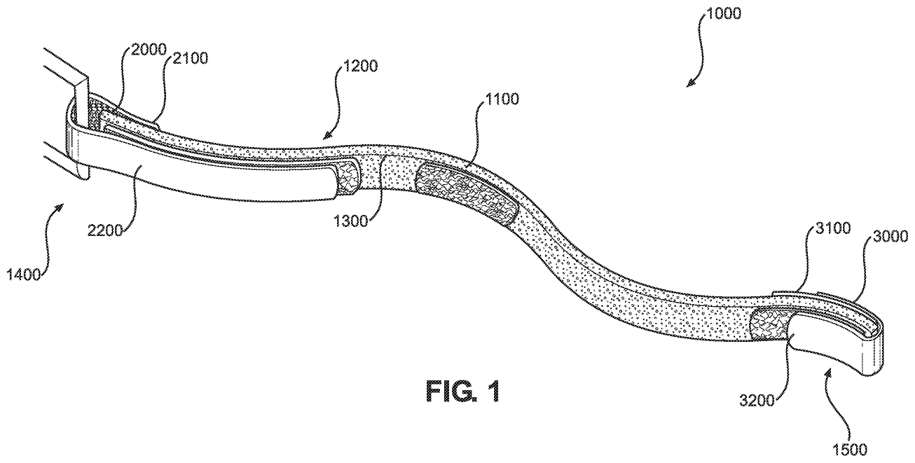

Referring now to FIG. 1, there is shown a perspective view of an embodiment of the multipurpose strap system. The multipurpose strap system 1000 provides a versatile and secure device for fastening items across various applications. One of the benefits of the present invention lies in the elimination of traditional hooks, as these hooks cause injuries and damage both secured items and their surroundings. The multipurpose strap system 1000 comprises an elongated main strap 1100 affixed to a first fastener 2000 and a second fastener 3000. The elongated strap 1100 includes a first side 1200, a second side 1300, a first end 1400, and a second side 1500. The first fastener 2000 includes a first component 2100 and a second component 2200, wherein the second component is disposed at first end 1400. The second fastener 3000 includes a first component 3100 of the second fastener and a second component 3200 of the second fastener is disposed at the second end 3000. In the shown embodiment, the first components 2100, 3100 of the first and second fasteners 2000, 3000 are substantially similar. In this way, the strap 1100 is reversable and usable at either end 1400, 1500.

In the shown embodiment, a third fastener is positioned between the ends of the elongated strap 1100. The fasteners allows a user to selectively adjust the size of either the first and second fasteners 2000, 3000 such that the loop formed by the fasteners 2000, 3000 is widely adjustable. Specifically, for minor adjustment, the first and second fasteners 2000, 3000 are adjustable when coupling to the components, respectively. For larger adjustments, the first and/or second fasteners 200, 3000 are selectively fastened to the third fastener. As shown in FIG. 4, the third fastener 6000 is positioned anywhere between the first and second fasteners 2000, 3000 and additional fasteners may be used as well. In one embodiment, the first and second components 2100, 3100 are permanently attached to the strap 1300 which allows free end 2100 to loop around and attach. In this way, the strap 1300 is stronger and prevents the otherwise free end from being loose.

In one embodiment, the strap 1100 comprises a silicone-reinforced composition with fiberglass. In an alternative embodiment, the strap 1100 comprises a bungy material having some stretchability.

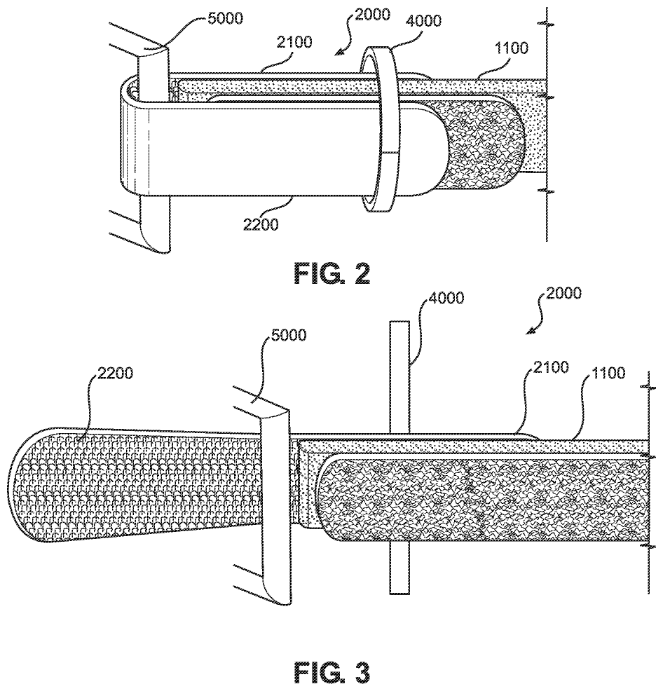

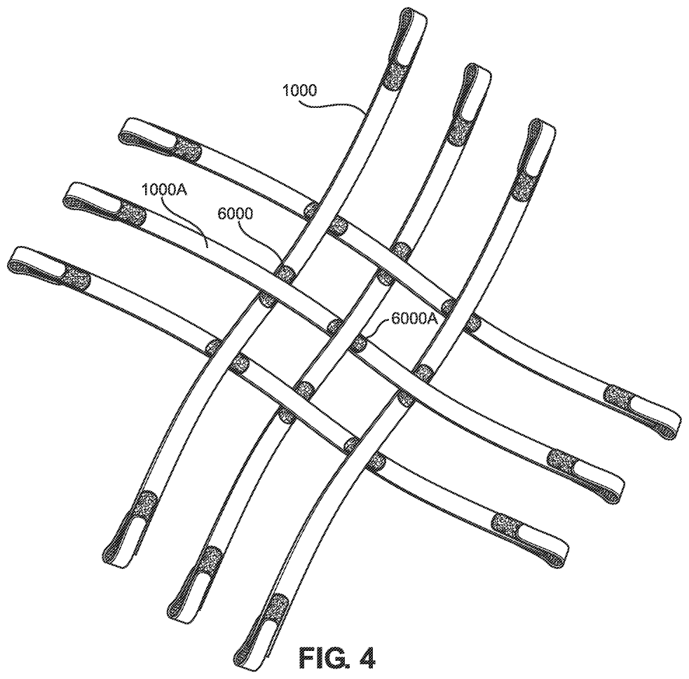

Referring now to FIGS. 2 and 3, there are shown close-up views of an embodiment of the first end of the multipurpose strap system in a closed configuration and an open configuration, respectively. In the shown embodiment, the first component 2100 of the first fastener 2000 and the first component 3100 of the second fastener 3000 are located on the first side 1200 of the elongated main strap 1100. The second component 2200 of the first fastener 2000 and the second component 3200 of the second fastener 3000 are located on the first side 1200 of the strap 1100 and extend past each distal end of the elongated main strap 1100. Moreover, the first components 2100, 3100 of the first and second fasteners 2000, 3000 are each configured to couple with the second component 2200, 3200 of the first and second fasteners 2000, 3000, respectively, and each form a closed loop. In this way, the first and second fasteners 2000, 3000 are adapted to secured objects by wrapping around the object, through the object, or otherwise fastening the object thereto.

In one exemplary use, the multipurpose strap system 1000 is used to secure a buckle 5000 to the first fastener 2000. A user handles the elongated strap 1100 to position the first end 1400 of the strap 1100 adjacent to the buckle 5000, and to ensure that the first fastener 2000 is in an open configuration (as shown in FIG. 2). The buckle 5000 is positioned within the fastener 2000, the fastener is closed to form a closed loop and secure the buckle 5000 thereto. The size of the closed loop is variable depending on the needs of the user. The second fastener 3000 (not shown) may be secured to a vehicle or other article. If securing additional objects or extending the length of the strap is required, repeat the process with other fasteners along the length of the strap to “daisy chain” with other straps.

In one embodiment, a securement strap 4000 is used to secure the first component and the second component 2100, 2200, 3100, 3200 to each other respectively. The securement strap 4000 is oriented perpendicular to the strap 1100 and the fasteners 2000, 3000 such that when the fasteners 2000, 3000 are in a closed configuration the securement strap 4000 is wrapped around both component 2100, 2200, 3100, 3200, respectively. In this way, the securement strap 4000 prevents the unwanted loosening or transition from the closed configuration to an open position.

Referring now to FIG. 4, there is shown a perspective view of an embodiment of the multipurpose strap system joined with multiple other straps in a net configuration. In one embodiment, the multipurpose strap system 1000 provides for a connection with other similar straps 1000A to form a net-like structure and configuration. In this net configuration, the straps 1000 enhances the versatility of the system by enabling users to secure larger items, create enclosures, or bundle multiple objects simultaneously. In the shown embodiment, the multipurpose strap system 1000 comprises a plurality of fastener components along its length, each providing attachment points for various items. In the shown embodiment, a third fastener 6000 is configured to secure to the first and second fasteners 2000, 3000 as well as the first, second, and third fasteners of other straps. The third fastener 6000 is disposed on a central region is disposed between the first end and the second end.

In one embodiment, the third fastener comprises a first component and a second component, forming a closed loop when coupled therewith. In the shown embodiment, the third fastener 6000 comprises a first component that is adapted to selectively fasten with a third fastener 6000A from a second similar straps 1000A. The third fastener 6000 is strategically placed towards the middle of the main strap, allowing for even distribution when multiple straps are interlinked. To create the net configuration, multiple multipurpose strap systems are utilized. The third fastener 6000 of one strap 1000 is coupled with the third fastener 6000A of another strap 1000A, forming a secure connection. Users can continue to interlink additional straps as needed, creating a network of connected straps. This process can be repeated to form a comprehensive net-like structure with the desired size and shape. The net configuration is particularly beneficial for securing larger items, such as bundles of equipment, camping gear, or irregularly shaped objects. The interlinked straps provide a comprehensive and even distribution of tension. This is advantageous in scenarios where items need to be kept together or protected during transportation.

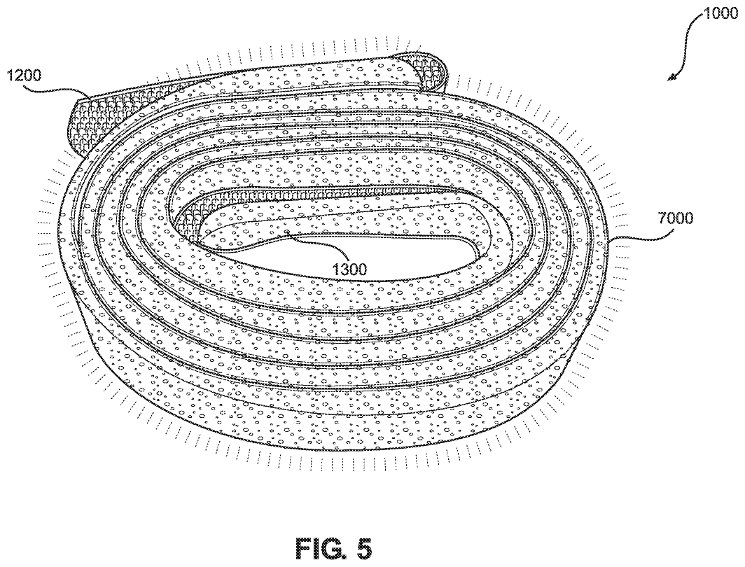

Referring now to FIG. 5, there is shown a perspective view of an embodiment of the multipurpose strap in a coiled configuration with a phosphorescent substrate to emit some light. In one embodiment, the multipurpose strap system incorporates a “glow in the dark” or phosphorescent element 7000 that provides visibility in low-light conditions. The phosphorescent feature is achieved by incorporating a substrate into the composition of the strap material. This substrate contains phosphorescent pigments or compounds that possess the unique property of absorbing and storing light energy when exposed to a light source.

In the absence of the light source, the phosphorescent molecules gradually release the stored energy in the form of visible light. This release is a slow process, creating a prolonged and subtle glow. As the stored energy is gradually released, the phosphorescent substrate emits a soft and visible glow in the dark surroundings. This glow enhances the visibility of the multipurpose strap system 1000 making it easily discernible even in low-light or nighttime conditions. In the shown embodiment, the phosphorescent element 7000 is distributed throughout the strap 1000 and extends between the first end and the second end 1200, 1300. In other embodiments, the phosphorescent element 7000 is positioned on distinct portions of the strap 1000, such as just the ends.

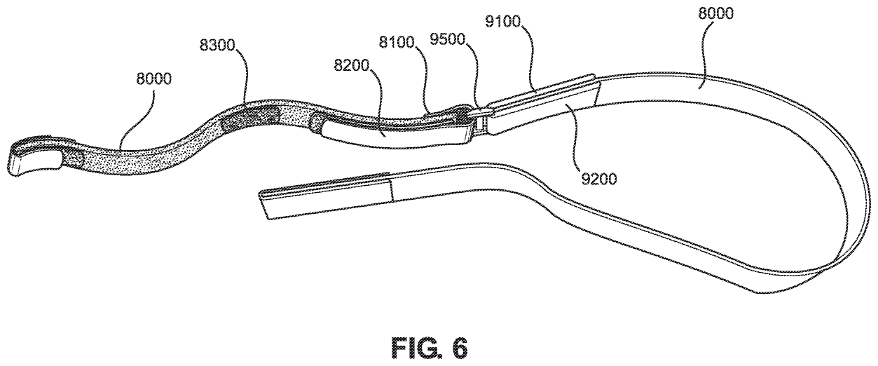

Referring now to FIG. 6, there is shown a perspective view of an embodiment of the multipurpose strap system with an elastic auxiliary cord 8000 affixed to a non-elastic auxiliary cord 9000. The inclusion of the elastic auxiliary cord 8000 introduces a dynamic aspect to the strap system, enabling it to accommodate heavier loads with improved durability compared to the silicone-based version. The elastic cord 8000, capable of supporting in excess of 100 lbs., is particularly useful for demanding applications, exemplified by its ability to securely hold two 50 lbs. bags of cement, demonstrating a total load capacity of 108 lbs. on a scale. This embodiment underscores the strap's versatility in handling varying weights and applications, making it an invaluable tool for securing heavy items while providing shock absorption when daisy-chained to cargo straps.

Furthermore, the multipurpose strap system allows for the substitution of silicon with other elastic materials, catering to a range of use cases from light to heavy-duty applications. While silicon options present an attractive choice for light-duty applications, such as dog collars, yoga mat ties, and bicycle accessories, and incorporating glow-in-the-dark features for appeal to younger users, the elastic material variant stands out for its robustness and heavy-duty performance.

In an alternative configuration of the auxiliary strap, the second component of the second fastener 3000, 3200 are detachable, offering flexibility in attachment and utility. This adaptability extends to the integration with cargo straps, enhancing the strap system application as a shock absorber for securing loads. This dual-material approach not only broadens the system's market appeal but also accommodates diverse user requirements.

In the shown embodiment, the auxiliary strap 8000 includes fasteners and components similar to that of the main multipurpose strap 1100, which ensures integration and functionality with the main strap. Each end of the auxiliary strap 8000 is equipped with a first component 8100 and a second component 8200. These components allow for the auxiliary strap to be easily attached to or detached from the main strap 1100, other auxiliary straps, or objects to be secured, providing added versatility and utility in application. The first component 8100 of the auxiliary strap's fasteners is designed to engage securely with the second component 8200, forming a closed loop akin to the main strap's fastening method. In the shown embodiment, a third fastener 8300 is shown that provides for the adjustment of the loop formed by the first and second component 8100, 8200. The third fastener 8300 is positioned anywhere between the first and second fasteners and is adapted to semi-permanently secure to either or both fasteners. This design ensures that the auxiliary strap can be utilized independently or in conjunction with the main strap for enhanced load-bearing capabilities and as a shock absorber when used in a daisy-chained configuration with cargo straps 9000. The inclusion of similar fasteners on the auxiliary strap allows for a modular and adaptable system capable of accommodating a wide range of securing needs, from light to heavy-duty applications.

In the shown embodiment, the non-elastic auxiliary cord 9000 is secured to the elastic auxiliary cord 8000 via a buckle 9500 that is interlocked with the first and second components 8100, 8200, 9100, 9200, respectively. The non-elastic cord 9000 comprises a fabric, silicone, or any other non-elastic material that resists stretching under tension. The non-elastic auxiliary cord 9000 may include a third fastener positioned anywhere between the first and second fasteners. In the shown embodiment, the non-elastic auxiliary cord 9000 includes only the first and second fasteners disposed at either end thereof. In one use of the shown configuration, the auxiliary cords 8000, 9000 are used in conjunction with the main strap to form a lease or tether to objects. The elastic auxiliary cord 8000 may be positioned at the distal end of the chain of cords to provide for some stretching to the attached object, while the remainder of the chain remains in a desired position.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A multipurpose strap system, comprising:
an elongated main strap affixed to a first fastener and a second fastener, the elongated strap having a first side, a second side, a first end, and a second side;
wherein the first fastener includes a first component and a second component, wherein the second component of the first fastener is disposed at the first end;
wherein the second fastener includes a first component of the second fastener and a second component of the second fastener disposed at the second end;
wherein the first component of the first fastener and the first component of the second fastener are located on the first side of the elongated main strap;
wherein the second component of the first fastener and the second component of the second fastener are located on the first side of the strap and extend past each distal end of the elongated main strap;
wherein the first component of the first and second fasteners are each configured to couple with the second component of the first and second fasteners, respectively, and each form a closed loop.

2. The multipurpose strap system of claim 1, wherein the second component of the first fastener and the second component of the second fastener are permanently affixed to the elongated main strap.

3. The multipurpose strap system of claim 2, wherein a central region of the elongated main strap includes a first component of a third fastener configured to mate with the first fastener or the second fastener.

4. The multipurpose strap system of claim 3, wherein the central region is disposed between the first end and the second end.

5. The multipurpose strap system of claim 4, wherein the first and second fasteners are hook and loop fasteners.

6. The multipurpose strap system of claim 5, wherein the third fastener comprises a hook and loop fastener.

7. The multipurpose strap system of claim 1, wherein the closed loop formed by each respective fastener is fixed.

8. The multipurpose strap system of claim 1, wherein the second component of the first fastener and the second component of the second fastener each extend past a distal end of the elongated main strap by at least 3 inches.

9. The multipurpose strap system of claim 1, wherein the elongated main strap is equipped with a plurality of fastener components along its length, each providing attachment points for various items.

10. The multipurpose strap system of claim 1, wherein an extension attachment comprises a foldable 4-inch extension, enabling the creation of a second loop for attaching additional items.

11. The multipurpose strap system of claim 5, further comprising an extension attachment attached to either the first fastener or the second fastener.

12. The multipurpose strap system of claim 1, wherein the elongated main strap comprises silicone reinforced with fiberglass.

13. The multipurpose strap system of claim 1, wherein the elongated main strap is continuous and elastic.

14. The multipurpose strap system of claim 1, wherein the elongated main strap includes a first section adjustably attachable to a second section to form an adjustable loop.

15. The multipurpose strap system of claim 1, wherein the elongated main strap is phosphorescent.
